(19) United States
(12) Patent Application Publication
(10) Pub. No.: US 2018/0077756 A1
(43) Pub. Date: Mar. 15, 2018

(54) STRIP-SHAPED CARBON HEATING FILAMENT AND METHOD FOR ITS PRODUCTION

(71) Applicant: Heraeus Noblelight GmbH, Hanau (DE)

(72) Inventors: Sven LINOW, Darmstadt (DE); Maike KLUMPP, Weiden (DE)

(21) Appl. No.: 15/560,344

(22) PCT Filed: Mar. 9, 2016
(86) PCT No.: PCT/EP2016/054953

§ 371 Date: Sep. 21, 2017

(30) Foreign Application Priority Data
Mar. 24, 2015 (DE) 10 2015 104 373.4

(51) Int. Cl. H05B 3/14; H05B 3/00

(52) U.S. Cl. CPC H05B 3/145; H05B 3/009; H05B 2203/032; H05B 2203/017; H05B 3/146

(57) ABSTRACT

A method for producing a heating filament made of a composite material and having a longitudinal axis is provided. Carbon fibers are embedded in a matrix made of carbon and a planar structure is prepared that contains carbon fibers in a textile bond. The planar structure is impregnated with thermoplastic material, and then the impregnated planar structure is carbonized in a protective gas or vacuum while forming the composite material. The planar structure is prepared from a fiber composite material, in which plastic threads made of the thermoplastic material are incorporated into the textile bond of the planar structure. The resulting carbon heating filament provides for the smallest possible material loss in the cutting process from a large surface area, namely to form a strip-shaped semi-finished product. Also, the resulting carbon heating filament filament has a high specific electrical resistance and is distinguished by high mechanical stability.

### CROSS-REFERENCE TO RELATED APPLICATIONS

This application is a Section 371 of International Application No. PCT/EP2016/054953, filed Mar. 9, 2016, which was published in the German language on Sep. 29, 2016 under International Publication No. WO 2016/150701 A1, and the disclosure of which is incorporated herein by reference.

### BACKGROUND OF THE INVENTION

An embodiment of the present invention relates to a strip-shaped carbon heating filament made of a composite material, in which carbon fibers are embedded in a textile bond in a matrix made of carbon.

An embodiment of the present invention also relates to a method for producing a heating filament made of a composite material and having a longitudinal axis, in which carbon fibers are embedded in a matrix made of carbon, comprising the following method steps:
(a) preparation of a planar structure, which contains carbon fibers in a textile bond,
(b) impregnation of the planar structure with a thermoplastic material, and
(c) carbonization of the impregnated planar structure while forming the composite material.

Carbon heating filaments are made of a carbon-carbon composite material, in which carbon threads generated from a carbon precursor of a first type are embedded in a matrix made of carbon generated from a carbon precursor of a second type.

The heating filament is used as a glow filament, glow wire, or spiral-wound filament for carrying a current in filament bulbs, infrared emitters, or ovens, and is usually provided in an elongated form as a smooth strip or a strip twisted or coiled about its longitudinal axis. Heating filaments based on carbon fibers exhibit good mechanical stability with simultaneously high electrical resistance, and they permit relatively quick temperature changes.

### PRIOR ART

In conventional use, the heating filaments are often exposed to continuous temperatures of 800° C. and higher. To ensure constant radiation emission, the electrical and mechanical properties of the heating filament must remain within a specified tolerance range for as long as possible, regardless of the temperature load.

With respect to the electrical properties, special attention is to be given to the electrical resistance of the heating filament. This should also be constant over time under load and, on the other hand, it should be as high as possible, in order to be able to also operate short heating filament lengths at typical voltages (for example, 230 V).

In a strip-shaped heating filament, the nominal electrical resistance is basically adjustable by the cross section and, in particular, by the thickness of the strip. The reduction of the strip thickness, however, is subject to limitations due to the mechanical strength and a specified minimum service life. These limitation are noticeable, in particular, when the heating filament is subject to high mechanical loading in use, as, for example, in the case of long irradiation lengths of 1 m or more.

From U.S. Pat. No. 6,845,217 B2, it is known to set the electrical resistance of the composite material of the heating filament by varying the percentages of crystalline carbon and amorphous carbon and by dopants, such as nitrogen or boron. The heating filament produced in this way, however, shows low mechanical stability.

EP 0 700 629 A1 proposes a heating filament in which a strip-shaped arrangement of carbon fibers is coated with a layer made of vitreous carbon. For forming contacts, thicker, bonded sections are provided at the strip ends, which are fixed and held in place by springs made of molybdenum sheet metal. In this way, the mechanical stability is increased, so that smaller strip thicknesses and thus higher electrical resistances are made possible.

However, the electrical resistance of this heating filament is still too low to be able to operate short emitters (<1 m) at the typical industrial voltages of around 230 V.

DE 10 2011 109 578 A1 proposes increasing the electrical resistance in a strip-shaped heating filament, by embedding a planar, irregular structure of relatively short carbon fibers in a carbon matrix having lower electrical conductivity. An electrical current flowing in an arbitrary direction runs at least in some areas through the carbon matrix, which increases the electrical resistance. The carbon matrix is generated by the carbonization of thermoplastic material. Suitable plastics include: polyether sulfone (PES), polyether ether ketone (PEEK), polyetherimide (PEI), polyethylene terephthalate (PET), polyphthalamide (PPA), polyphenylene sulfide (PPS), or polyimide (PI), wherein PEEK and PET are especially preferred. Before the carbonization of the plastic, the heating filament is cut to the desired dimensions. The carbon fibers are based, for example, on polyacrylonitrile (PAN), tar, or viscose.

In the similar approach according to DE 10 2011 109 577 A1, a regular structure made of carbon fibers is embedded in a carbon-based matrix having low electrical conductivity, wherein before and after the production of the matrix, at least one part of the carbon fibers is interrupted viewed in one possible direction of flow, for example, by generating passage holes. By the number of breaks and the percentage of broken carbon fibers, the percentage of the current flow that is forced through the matrix material, and thus the electrical resistance of the composite material, can be adjusted. The carbon fiber structure comprises, for example, a woven material, a mesh material, a knitted material, or a knotted material of fibers or fiber bundles. To further increase the electrical resistance, in one embodiment, a strip-shaped heating filament made of a large planar semi-finished product is cut, so that the fiber longitudinal axes enclose an angle with the final heating filament longitudinal axis, which is not equal to zero. This, however, leads to cutting losses in the already impregnated and therefore considerably processed and expensive preliminary material.

For the two last-explained constructions of the carbon heating filament, the electrical resistance can be influenced to a certain extent by orienting the carbon fibers having good electrical conductivity with reference to the current flux direction or by the degree of their discontinuity. This gain in variability of the electrical resistance, however, comes at the expense of mechanical stability. It has also been shown that an orientation of the carbon fibers at a large angle to the current flux direction can lead to distortions of the strip and to short service lives.

### BRIEF SUMMARY OF THE INVENTION

Some embodiments of the present invention are therefore based on an objective of modifying such a carbon heating filament so that, on one hand, the carbon heating filament has a specific electrical resistance that is high enough so that it can also be operated for short irradiation lengths of 1 m and smaller at an industrially typical electrical voltage of 230 V and, on the other hand, the carbon heating filament is distinguished by a high mechanical stability and a long service life.

Some embodiments of the present invention are further based on an objective of providing a method for producing such a carbon heating filament, in which material losses are low, such as those due to cutting from a large planar, strip-shaped, semi-finished product.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

The invention will be explained in more detail below with reference to embodiments and a drawing.

In the drawings:

FIG. 1 is a mesh structure in schematic representation as a semi-finished product for producing a heating filament, according to an embodiment of the present invention;

FIG. 2 is a preform of the heating filament in a section view and in schematic representation provided with electrical connections, according to an embodiment of the present invention;

FIG. 3 is a photo of the heating filament after the carbonization, according to an embodiment of the present invention;

FIG. 4 is a diagram for the voltage per heated heating filament length as a function of the temperature, according to an embodiment of the present invention; and

FIG. 5 is a diagram showing the dependency of the specific electrical resistance on the fiber crossing angle in a meshwork, according to an embodiment of the present invention.

### DETAILED DESCRIPTION OF THE INVENTION

With respect to an embodiment of the method for producing the heating filament, the above-discussed objectives are achieved starting from a method of the generic type mentioned above. Specifically, a planar structure is provided from a fiber composite material in which the plastic threads made of thermoplastic material are incorporated into the textile bond of the planar structure.

The fiber composite material contains a regular or irregular carbon fiber structure in which additional plastic threads are incorporated. The plastic threads preferably form their own thread system within the carbon fiber structure, and are provided there as individual threads or multi-filament threads. However, the plastic threads can also be processed with carbon fibers in a common thread system, and optionally form so-called “hybrid threads”.

The dimensions of the semi-finished product from the fiber composite material can be close to the final contour of the heating filament. Usually, however, the fiber composite material is provided as a strip-shaped semi-finished product, from which a preform of the heating filament is produced, for example, by cutting or punching. The cut edges are ideally parallel to the longitudinal sides of the strip-shaped semi-finished product, in order to minimize material losses.

The elongated heating filament produced in this way usually has a strip or plate-shaped form. It is flat or extends in three spatial directions by being, for example, coiled or twisted. In conventional use, the heating current flows through the elongated heating filament from one end to its opposite end. The current flux direction and heating filament longitudinal axis are thus essentially parallel.

The specific electric conductivity of the heating filament is influenced by the type, quantity, distribution, and orientation of the carbon fibers. In principle, the electrical resistance becomes greater the higher the degree of any discontinuity of the textile carbon fiber structure in the current flux direction, and the greater the average angle is that the heating filament longitudinal axis encloses with those carbon fibers whose orientations have a directional vector in the current flux direction.

This angle is also designated herein, for the sake of simplicity, as “divergence angle.” A high electrical resistance is desired when it concerns, even for a short heating filament length, an operation at an electrical voltage of 230 V, which is typical in industrial practice. However, increasing the degree of discontinuity and divergence angle negatively affects the mechanical stability of the semi-finished product in the processing to form the heating filament. Thus, when cutting previous semi-finished products, this easily led to tears and fractures and especially to fraying along the cut heating filament longitudinal sides.

These losses in mechanical stability work against the refinement of the fiber composite material semi-finished product, according to an embodiment of the present invention, in that threads made of thermoplastic material are already incorporated during the production of the textile carbon fiber structure. These plastic threads are also incorporated in the bond of the planar structure, but they preferably form at least one part of the also otherwise required structural threads of the textile bond, for example, according to the bond type, stay threads, warp threads, transverse threads, or binder threads.

Independent of their specific function within the textile bond, the plastic threads have a stabilizing effect on the semi-finished product. Indeed, on one hand, in the cutting or punching of the heating filament, the tear resistance or fracture toughness of the relatively brittle carbon fiber structure is increased by the plastic threads, due to their high elasticity compared to carbon fibers. This acts against tearing or fraying even for a large divergence angle. In addition, plastic threads running in the longitudinal axis direction are able to absorb tensile forces that occur in this direction during the further processing of the semi-finished product, and thus counteract distortion or changing of the preset bond angle of the textile bond. In a strip-shaped semi-finished product, the stabilization caused by the plastic threads contributes to the fact that the heating filaments can be cut or punched despite the large divergence angle without tearing or deformation parallel to the strip longitudinal axis.

On the other hand, the thermoplastic threads also contribute in the further processing of the heating filament to its stabilization, in that they soften during impregnation under heating, penetrate the carbon fiber structure in their location, and then can form at least part of the plastic in the consolidated planar structure.

Elongated heating filaments (in the specified length and width) are cut from the consolidated carbon fiber woven material.

The plastic threads develop their stabilizing effect regardless of the carbon fiber structure present in the individual case. The structure is either single layer or multi-layer. With respect to its orientation, however, plastic threads oriented in the direction of the heating filament longitudinal axis have proven especially effective. These plastic threads thus run parallel to the longitudinal sides of the heating filament, and are approximately parallel to the middle current flux direction.

In one especially preferred embodiment of the method, a plurality of plastic threads are distributed uniformly over the width of the heating filament.

The “width” of the heating filament is the distance between the two parallel longitudinal sides. A plurality of plastic threads (e.g., at least three plastic threads) which are formed, for example, as stay or warp threads of the textile bond, are distributed uniformly over this dimension.

In one alternative, but preferably similar embodiment of the method, the heating filament is provided with two parallel longitudinal sides, wherein the plastic threads run predominantly in the region of the two longitudinal sides.

The heating filament is here cut or punched from the planar structure, so that the stabilizing plastic threads are provided predominantly or exclusively along the two parallel longitudinal sides. The plastic threads are “predominantly” arranged on the longitudinal sides when their surface area occupation (i.e., the number per unit of length) is greatest on these sides. This embodiment of the method is advantageous, for example, when the plastic threads actually make the generation of the textile planar structure more difficult, and therefore are provided only at those positions at which they achieve an especially advantageous effect with respect to mechanical stabilization, that is, in the region of the longitudinal sides of the heating filaments, to be produced from the planar structure.

In one especially preferred construction, the plastic threads enclose an angle between 10 and 80 degrees with the carbon fibers in the fiber composite material.

In plastic threads running parallel to the heating filament longitudinal axis, the carbon fibers form, in these cases, a large divergence angle with the heating filament longitudinal axis, accompanied by the advantages already explained above with respect to the electrical resistance of the heating filament.

The fiber composite material is composed, for example, from structural and functional threads together, which form a woven, knotted, knitted, stitched, meshwork, crocheted, felt or fulled material, or fleece (e.g., nonwoven).

In one especially preferred embodiment of the method, however, the fiber composite material is provided as a knit, which has a knitted structure with stitches and stay threads incorporated therein, wherein a plurality of stay threads made of plastic threads is provided, preferably in each of the stitches. Such knitted materials are typically produced by warp knitting machines or Raschel machines with weft insertion. They typically comprise, and more particularly consist of, a vertical knitted structure having a horizontal weft insertion. The vertical knitted structure comprises a stitch structure and optionally stay threads incorporated in this structure. In the knitted material, a stay thread can be provided in each stitch of the knitted material, or it is possible to provide one or more stitches without stay threads in addition to a stitch of the knitted material provided with stay threads.

In one alternative embodiment of the method, the fiber composite material is constructed as a meshwork, which has a mesh structure having stay threads incorporated therein, of which at least two, and more preferably all, are formed from plastic thread.

Meshwork structures in the form of round meshwork can be produced by braiding over so-called mesh cores. The mesh threads are here wound on coils and clamped in coil holders (bobbins) that are moved by vanes. In one round meshwork, half of the bobbin moves in the clockwise direction, while the other half moves in the counterclockwise direction. In a biaxial mesh thread system, the half angle between the two mesh thread systems is designated as a “mesh angle.” For the introduction of a third thread system into the meshwork, these threads are not moved at the same time, but are instead introduced into the meshwork at a fixed position as so-called stay threads. At least one part of these stay threads of a tri-axial thread system is constructed, according to an embodiment of the present invention, as plastic threads made of thermoplastic material. At least one of the two other mesh thread systems comprises, and more particularly consists of, carbon fiber.

In contrast to the woven material, for the mesh angle, there is no restriction to a vertical angle, so that the size of the mesh angle delivers an additional degree of freedom for setting the electrical resistance of the heating filament.

In another advantageous embodiment of the method, the fiber composite material is constructed as a woven material, which has a woven structure having warp threads running in the longitudinal direction and transverse threads running perpendicular or at a different angle to the warp threads. The majority, and preferably each, of the warp threads is formed from plastic thread.

The planar structure in the form of a carbon fiber woven material is mechanically especially stable, features low distortion and can be produced easily in comparison with other textile structures, such as a meshwork, knitted, or knotted material.

The production of the fiber composite material is simplified if the carbon fibers and plastic threads have similar diameters. The larger the percentage of plastic threads is in the fiber composite material, the greater is their contribution to the mechanical stabilization of the semi-finished product. On the other hand, the plastic threads after the carbonization form only a part of the carbon matrix, which contributes less than the carbon fibers to the strength of the final heating filament. As a suitable compromise, it has proven effective if the volume percentage of carbon fibers in the fiber composite material is in a range between 50% and 60%.

The fineness of linear textile structures is defined according to ISO 1144 and DIN 60905, part 1 in the so-called “tex system” as weight per unit of length. 1 tex corresponds to 1 gram per 1000 meter.

With respect to sufficient mechanical strength and highest possible electrical resistance, it has proven effective if the carbon fibers have a fineness in a range of 0.05 to 0.09 tex, and the fiber composite material is provided with a surface area weight in a range of 100 to 300 g/m².

It has also proven effective if the plastic threads of the fiber composite material contain polyether ether ketone (PEEK).

PEEK is a high-temperature-resistant thermoplastic material and belongs to the polyaryletherketone family. It has a high carbon content after the carbonization process. Its melting point is 335° C.

The quantity of plastic threads incorporated in the fiber composite material is designed, for example, so that no additional plastic is required for impregnation. As an alternative, for impregnation, the fiber composite material is brought into contact with other thermoplastic material and heated. In the simplest case, the other thermoplastic material is the same as the plastic threads. It is provided in fiber form, particulate form, or in the form of a film. For the impregnation, the fiber composite material can also be arranged in a sandwich-like arrangement between films made of thermoplastic material lying on each side.

For the further solidification, the impregnated planar structure is preferably consolidated by heating and here held in a tool under pressure at elevated temperature until a close wetting of the PEEK and the carbon fibers is set. To keep the stress or distortion to a minimum, the consolidation preferably also comprises the cooling of the impregnated fiber composite material in the tool, while maintaining a compressive pressure.

The carbonization of the consolidated planar structure is preferably realized in a protective gas or vacuum through resistance heating or heating in a furnace. A subsequent graphitizing can also be used for setting a higher electrical conductivity. The graphitizing is performed at temperatures between 1500° C. and 3000° C. in an inert atmosphere at atmospheric pressure or also in a vacuum.

With respect to the heating filament, the objectives mentioned above are solved according to embodiments of the present invention, in that the textile bond comprises a thread system made of first carbon fibers and second carbon fibers, wherein the first carbon fibers enclose a fiber crossing angle α in a range of 45 to 135 degrees with the second carbon fibers, and it has a specific electrical resistance of at least 25 Ωmm²/m at a filament temperature in a range of 900° C. to 1600° C.

The heating filament according to an embodiment of the present invention is obtained from a composite material that is produced according to at least one of the embodiments of the method explained above. This composite material contains carbon fibers in a carbon-containing matrix. In a semi-finished product of the composite material, the carbon fibers can be oriented at a large angle relative to the current flux direction (of the heating filament) or can be discontinued to a large degree, so that they cause a relatively high electrical resistance. The semi-finished product contains threads made of a thermoplastic material and having a stabilizing effect on the semi-finished product, and thus enable further processing to the defect-free or low-defect heating filament having a high specific electrical resistance. The specific electrical resistance of the heating filament, according to an embodiment of the present invention, is at least 25 Ωmm²/m at a temperature in a range of 900° C. to 1600° C. The typical operating temperatures of heating filaments are in this temperature range.

The textile bond comprises a thread system made of first carbon fibers and second carbon fibers, wherein the first carbon fibers enclose a fiber crossing angle α in a range of 45 to 135 degrees with the second carbon fibers.

The fiber crossing angle is, in this case, twice as large as the divergence angle, that is, the angle between the carbon fibers and the heating filament longitudinal axis. The larger this angle is, the higher the specific electrical resistance of the heating filament becomes. Fiber crossing angles in a range of 45 to 135 degrees thus enable a divergence angle in a range of 22.5 and 67.5 degrees. One special feature of the method and the heating filament according to embodiments of the invention is that the relatively large fiber crossing angle is formed in the strip-shaped composite material and is obtained by cutting the heating filament preforms along the strip longitudinal sides.

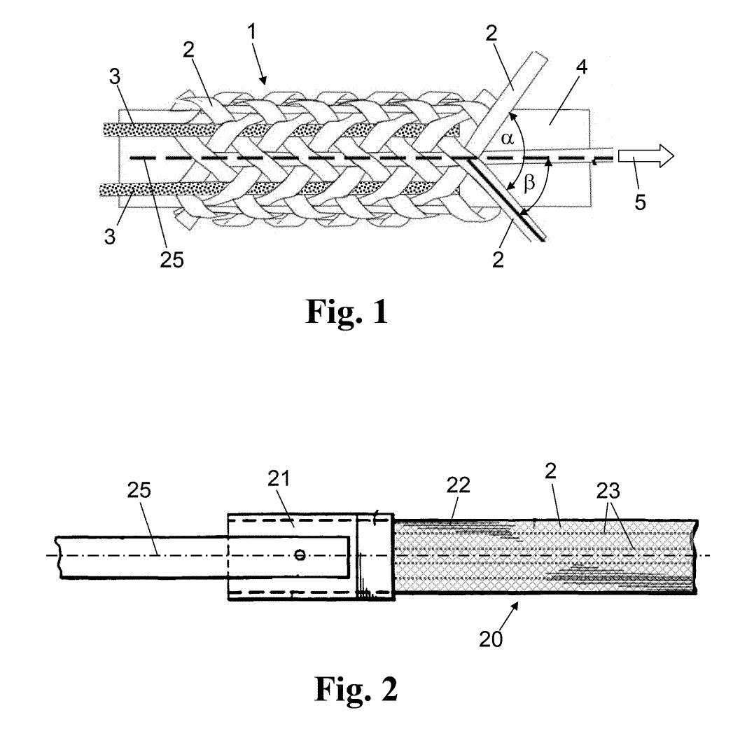

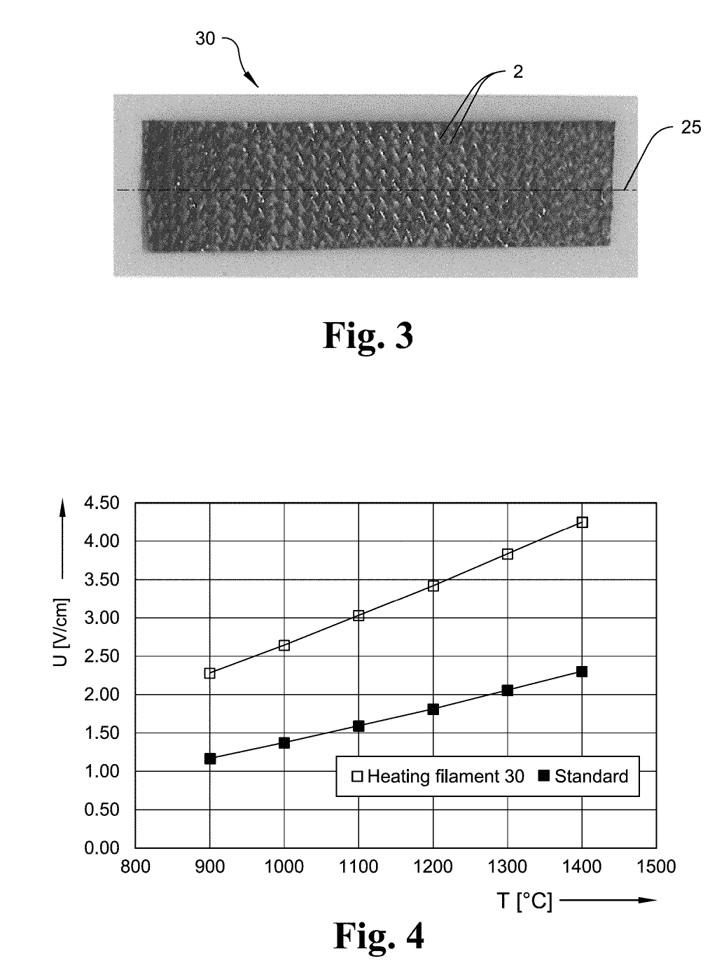

FIG. 1 schematically shows a semi-finished product 1 in the form of a tri-axial round meshwork made of carbon fibers 2, in which stay threads 3 made of plastic are incorporated. The plastic stay threads 3 are distributed uniformly about the meshwork core 4, and they run in the direction of movement 5 of the meshwork core 4 in the radial meshwork process. This direction 5 corresponds to the longitudinal axis direction 25 of the heating filament (see FIGS. 2 and 3), which is produced from the semi-finished product. The mesh angle β between the two carbon fiber systems is 67.5 degrees, the fiber crossing angle α is, in this case, 135 degrees.

The carbon fibers 2 have a fineness of 0.07 tex. The plastic stay threads 3 are made of a PEEK fiber bundle and have a fineness of 1107 denier (“denier” is a dimensional unit for the yarn fineness and stands for mass per 9000 m). The meshwork 1 produced in this way is flexible and has a surface weight of 300 g/m².

The final round meshwork is cut in the direction of its longitudinal axis 25, so that a ribbon meshwork is obtained whose width is determined by the peripheral surface of the round meshwork. The plastic stay threads 3 stabilize the meshwork 1 for its further processing. Due to its high elasticity in comparison with the carbon fibers 2, the tearing resistance and the fracture toughness increase in comparison to a pure carbon fiber structure. In addition, plastic threads 3 running in the longitudinal axis direction 5 are able to absorb tensile forces occurring during the further processing of the meshwork 1, and thus counteract a shift or a change of the preset mesh angle.

The plastic stay threads 3 soften under heat, so that the plastic mass penetrates the carbon fiber structure in its location and then forms a part of the plastic in the consolidated planar structure. In the embodiment, the weight percentage of plastic stay threads 3, however, is not sufficient for a complete impregnation of the meshwork structure 1. Therefore, for impregnation on both sides, a PEEK film having a thickness of 75 pm is applied and heated in a heating press at a temperature around 360° C. and at a pressure of 5 bar. This measure alone, however, still does not produce an extremely stable filament. A higher mechanical stability is achieved in the same heating process by a consolidation process in which the composite material made of carbon fiber and plastic threads is heated in the heating press at a temperature around 400° C. and a pressure of 10 bar and is held at these conditions for an additional 15 minutes.

The consolidated composite material is provided as a band whose width corresponds to a multiple of the desired width of 15 mm for the heating filament 1. Corresponding width strips in the desired length are cut parallel to the longitudinal sides of the band and any irregularities on the cut sides are removed. The cutting directions run parallel to the former plastic threads 3 and vertically. Although the carbon fibers enclose a crossing angle α of 135 degrees with each other and an angle of approximately 67.5 degrees with the cut edge (i.e., this is the divergence angle and corresponds to the mesh angle β), the cutting losses are small.

After the cutting of the band, electrical connections 21 are applied, as shown schematically in FIG. 2. The heating filament preform 20 is provided as a composite material made of a carbon fiber meshwork 2, which is embedded in a plastic matrix 22. A part of the plastic matrix 22 is formed by the former plastic stay threads 3, whose profile is indicated as dotted lines 23. These run parallel to the longitudinal axis 25 of the heating filament preform 20 and also of the heating filament 30 produced therefrom (see FIG. 3).

The volume percentage of the carbon fibers 2 is approximately 55% for this composite material 20. This is carbonized while forming the heating filament. The carbonization is typically performed by heating in a furnace at a temperature around 1000° C. in an inert atmosphere. Here, hydrogen, oxygen, and nitrogen, and optionally other elements are eliminated, in particular, from the plastic material surrounding the carbon fibers, so that only a carbon-carbon composite material having a high carbon content is produced.

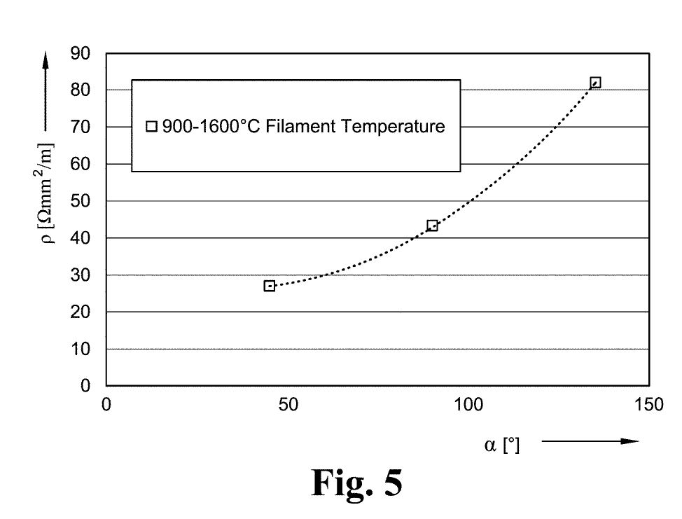

FIG. 3 shows a photo of a section of the heating filament 30 generated in this way. The heating filament 30 has a width of 10 mm, a thickness of 0.21 mm, and a length of 1 m. The carbon fibers 2 enclose a crossing angle α of 135 degrees with each other, and the mesh angle β is thus 67.5 degrees. It is distinguished by a high specific electrical resistance that is approximately 80 Ωmm²/m in a temperature range of 900° C. to 1600° C. (see FIG. 5). Therefore, the heating filament can also be operated with irradiation lengths of less than 1 m at a network voltage of 230 V.

This also becomes clear in the diagram of FIG. 4, in which the voltage U per heated length (in V/cm) is plotted as a function of the temperature T (in ° C.), that is, for the heating filament 30 according to the present embodiment of the invention in comparison with a standard material. Accordingly, the heating filament 30 according to an embodiment of the present invention achieves, in the relevant temperature range of 900° C. to 1400° C., a voltage of 2.3 to 4.25 V/cm with respect to the heating length. Thus, heated lengths between 540 mm and 1000 mm can be realized at a nominal voltage of 230 V. In comparison, with heating filaments made of the standard material at the same nominal voltage can be reached only with greater heated lengths in a range of 1150 mm to 2000 mm.

In the diagram of FIG. 5, the specific electrical resistance ρ (in Ωmm²/m) of the heating filament 30 is plotted on the ordinate with respect to the crossing angle α (in angular degrees °) on the abscissa. From this, it is clear that the specific electrical resistance ρ increases with the fiber crossing angle α. Thus, for a fiber crossing angle of 45 degrees, the specific electrical resistance has a value of approximately 28 Ωmm²/m and for a fiber crossing angle of 135 degrees, it has a value of approximately 80 Ωmm²/m. The specific electrical resistance is here approximately constant for the heating filament temperatures in a range of 900° C. to 1600° C.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-15. (canceled)

16. Method for producing a heating filament made of a composite material and having a longitudinal axis, in which carbon fibers are embedded in a matrix made of carbon, the method comprising the following steps:
(a) preparing a planar structure comprising the carbon fibers in a textile bond;
(b) impregnating the planar structure with a thermoplastic material; and
(c) carbonizing the impregnated planar structure while forming the composite material,
wherein the planar structure is prepared from a fiber composite material, in which plastic threads made of the thermoplastic material are incorporated into the textile bond of the planar structure.

17. Method according to claim 16, wherein the plastic threads form structural threads of the textile bond.

18. Method according to claim 16, wherein the plastic threads are oriented in the direction of the heating filament longitudinal axis.

19. Method according to claim 18, wherein a plurality of the plastic threads are distributed uniformly across a width of the heating filament.

20. Method according to claim 16, wherein the heating filament is provided with two longitudinal sides running parallel to each other and wherein the plastic threads run predominantly in the area of both longitudinal sides.

21. Method according to claim 16, wherein in the fiber composite material, the plastic threads enclose an angle between 10 and 80 degrees with the carbon fibers.

22. Method according to claim 16, wherein the fiber composite material is constructed as a knitted fabric having a knitted fabric structure with stitches and stay threads incorporated therein, and wherein a stay thread made of the plastic thread is provided in the majority of the stitches.

23. Method according to claim 16, wherein the fiber composite material is constructed as a meshwork having a mesh structure comprising stay threads incorporated therein, of which at least two are formed from the plastic threads.

24. Method according to claim 16, wherein the fiber composite material is constructed as a woven material having a woven structure comprising warp threads running in a longitudinal direction and transverse threads running perpendicular to the warp threads or at a different angle relative to the warp threads, and wherein a majority of the warp threads are formed from the plastic threads.

25. Method according to claim 16, wherein the volume percentage of carbon fibers in the fiber composite material is in a range between 50 and 60 vol. %.

26. Method according to claim 16, wherein the carbon fibers have a fineness in the range of 0.05 to 0.09 tex and the fiber composite material is provided with a surface weight in the range of 100 to 300 g/m².

27. Method according to claim 16, wherein the plastic threads of the fiber composite material contain polyether ether ketone (PEEK).

28. Method according to claim 16, wherein in the impregnation step, the fiber composite material is arranged sandwich-like between foils of the thermoplastic material lying on each side.

29. Method according to claim 16, wherein the impregnated planar structure is consolidated by being heated in a tool under pressure.

30. Strip-shaped heating filament comprising:
a composite material in which carbon fibers are embedded in a textile bond in a matrix made of thermoplastic carbon material,
wherein the textile bond comprises a thread system made of first carbon fibers and second carbon fibers,
wherein the first carbon fibers enclose, with the second carbon fibers, a fiber crossing angle α in a range of 45 to 135 degrees, and
wherein the heating filament has a specific electrical resistance of at least 25 Ωmm²/m at a filament temperature in a range of 900° C. to 1600° C.
